(19) United States
(12) Patent Application Publication
(10) Pub. No.: US 2009/0142194 A1
(43) Pub. Date: Jun. 4, 2009

(54) METHOD AND SYSTEMS FOR MEASURING BLADE DEFORMATION IN TURBINES

(75) Inventors: Sam D. Draper, Simpsonville, SC (US); Scott M. Hoyte, Marietta, GA (US); Eric Gebhardt, Roswell, GA (US); Erin K. Bauknight, Seneca, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/947,875

(22) Filed: Nov. 30, 2007

(51) Int. Cl. F01D 5/14; F01D 5/22; G01H 11/00; G01H 1/00

(52) U.S. Cl. 416/190; 73/660

(57) ABSTRACT

A tip shrouded turbine blade that may include a target pad disposed on an outer radial surface of the tip shroud, the target pad including a raised surface that protrudes radially outward from the outer face of the tip shroud. The target pad may be substantially cylindrical in shape such that an outer radial face of the target pad is substantially circular in shape. The size of the surface area of the outer radial face of the target pad may be configured to be substantially the same size as an area of measurement for a conventional proximity sensor.

### BACKGROUND OF THE INVENTION

This present application relates generally to methods and systems for determining turbine blade deformation. More specifically, but not by way of limitation, the present application relates to methods and systems for measuring turbine blade deformation while the turbine is operating.

The turbine blades of industrial gas turbines and aircraft engines operate in a high temperature environment, where the temperatures regularly reach between 600° C. and 1500° C. Moreover, the general trend is to increase the turbine operating temperatures to increase output and engine efficiencies. Thermal stresses placed on the turbine blades associated with these conditions are severe.

In general, turbine blades undergo high level of mechanical stress due to the forces applied via the rotational speed of the turbine. These stresses have been driven to even higher levels in an effort to accommodate turbine blade design that include higher annulus areas that yield higher output torque during operation. In addition, the desire to design turbine blade tip shrouds of greater surface area has added addition weight to the end of the turbine blade, which has further increased the mechanical stresses applied to the blades during operation. When these mechanical stresses are coupled with the severe thermal stresses, the result is that turbine blades operate at or close to the design limits of the material. Under such conditions, turbine blades generally undergo a slow deformation, which is often referred to as “metal creep.” Metal creep refers to a condition wherein a metal part slowly changes shape from prolonged exposure to stress and high temperatures. Turbine blades may deform in the radial or axial direction.

Similarly, compressor blades undergo a high level of mechanical stress due to the forces applied via the rotational speed of the compressor. As a result compressor blades also may undergo the slow deformation associated with metal creep.

As a result, the turbine blade and compressor blade failure mode of primary concern in a turbine is metal creep, and particularly radial metal creep (i.e., elongation of the turbine or compressor blade). If left unattended, metal creep eventual may cause the turbine or compressor blade to rupture, which may cause extreme damage to the turbine unit and lead to significant repair downtime. In general, conventional methods for monitoring metal creep include either: (1) attempting to predict the accumulated creep elongation of the blades as a function of time through the use of analytical tools such as finite element analysis programs, which calculate the creep strain from algorithms based on creep strain tests conducted in a laboratory on isothermal creep test bars; or (2) visual inspections and/or hand measurements conducted during the downtime of the unit. However, the predictive analytical tools often are inaccurate. And, the visual inspections and/or hand measurements are labor intensive, costly, and, often, also yield inaccurate results.

In any case, inaccurate predictions as to the health of the turbine or compressor blade, whether made by using analytical tools, visual inspection or hand measurements, may be costly. On the one hand, inaccurate predictions may allow the blades to operate beyond their useful operating life and lead to a blade failure, which may cause severe damage to the turbine unit and repair downtime. On the other hand, inaccurate predictions may decommission a turbine or compressor blade too early (i.e., before its useful operating life is complete), which results in inefficiency. Accordingly, the ability to accurately monitor the metal creep deformation of turbine and/or compressor blades may increase the overall efficiency of the turbine engine unit. Such monitoring may maximize the service life of the blades while avoiding the risk of blade failure. In addition, if such monitoring could be done without the expense of time-consuming and labor-intensive visual inspections or hand measurements, further efficiencies would be realized. Thus, there is a need for improved systems for monitoring or measuring the metal creep deformation of turbine and compressor blades.

### BRIEF DESCRIPTION OF THE INVENTION

The present application thus describes a tip shrouded turbine blade that may include a target pad disposed on an outer radial surface of the tip shroud, the target pad including a raised surface that protrudes radially outward from the outer face of the tip shroud. The target pad may be substantially cylindrical in shape such that an outer radial face of the target pad is substantially circular in shape. The size of the surface area of the outer radial face of the target pad may be configured to be substantially the same size as an area of measurement for a conventional proximity sensor.

The tip shrouded turbine blade further may include a seal rail. The seal rail may include a fin that projects radially outward from the outer surface of the tip shroud. The radial height of the target pad may be less than the radial height of the seal rail. In some embodiments, the target pad is separate from the seal rail. In other embodiments, the target pad is part of the seal rail.

The present application further describe a set of tip shrouded turbine blades wherein: 1) each tip shrouded turbine blade may include a target pad disposed on an outer radial surface of the tip shroud; 2) the target pad may include a raised surface that protrudes radially outward from the outer face of the tip shroud; and 3) the surface profile of the target pad for each of the tip shrouded turbine blades may be configured to be distinguishable from the surface profile of the target pads for the other tip shrouded turbine blades in the set.

The present application further describe a blade for use in a turbine, the blade including a target pad disposed on an outer radial surface of the blade, wherein the target pad may include a raised surface that protrudes radially outward from the outer radial surface of the blade. The target pad may be substantially cylindrical in shape such that an outer radial face of the target pad is substantially circular in shape.

The present application further describe a system for determining the radial deformation of a tip shrouded turbine blade wherein the system may include: 1) one or more proximity sensors disposed around the circumference of a stage of blades, wherein the one or more proximity sensors take at least an initial measurement and a second measurement of the blade; 2) a control system that receives measurement data from the proximity sensors; and 3) a target pad disposed on the outward radial face of the tip shroud. The control system may be configured to determine a radial deformation of the blade by comparing the initial measurement to the second measurement. The initial measurement and second measurement each may indicate the distance from a tip of the blade to the one or more proximity sensors. The initial measurement and the second measurement may be taken while the turbine is operating.

In some embodiments, the number of the proximity sensors may include two or more proximity sensors. In such embodiments, the control system may determine a rotor displacement from the measurements taken by the two or more proximity sensors, and he control system may account for the rotor displacement when making the determination of the radial deformation of the blade.

In other embodiments, the number of the proximity sensors may include one proximity sensor the control system measures a rotor displacement with one or more rotor probes; and 2) the control system accounts for the rotor displacement when making the determination of the radial deformation of the blade.

The target pad may include a raised surface that protrudes radially outward from the outer face of the tip shroud. The target pad may be substantially cylindrical in shape such that an outer radial face of the target pad is substantially circular in shape. The size of the surface area of the outer radial face of the target pad may be configured to be substantially the same size as an area of measurement for a conventional proximity sensor.

The system may further include a seal rail that includes a fin projecting radially outward from the outer surface of the tip shroud. The radial height of the target pad may be less than the radial height of the seal rail. In some embodiments, the target pad may be separate from the seal rail. In other embodiments, the target pad may be part of the seal rail.

### BRIEF DESCRIPTION OF THE DRAWINGS

FIG. 1 is a perspective cut-away view of a gas turbine demonstrating an exemplary turbine in which an embodiment of the present invention may be used.

FIG. 2 is a cross-sectional view of the gas turbine of FIG. 1 demonstrating an exemplary embodiment of the present invention.

FIG. 3 is a cross-sectional view of the gas turbine of FIG. 1 demonstrating the circumferential placement of the proximity sensors according to an exemplary embodiment of the present invention.

FIG. 4 is a cross-sectional view of the gas turbine of FIG. 1 demonstrating an exemplary embodiment of the present invention.

FIG. 5 is a cross-sectional view of the gas turbine of FIG. 1 demonstrating an exemplary embodiment of the present invention.

FIG. 6 is a side view of a conventional tip shrouded turbine blade.

FIG. 7 is a top view of the tip shrouded turbine blade of FIG. 6.

FIG. 8 is a perspective view of a tip shroud with seal rail and a target pad according to an exemplary embodiment of the present application.

FIG. 9 is a perspective view of a tip shroud with seal rail and a target pad according to an alternative exemplary embodiment of the present application.

### DETAILED DESCRIPTION OF THE INVENTION

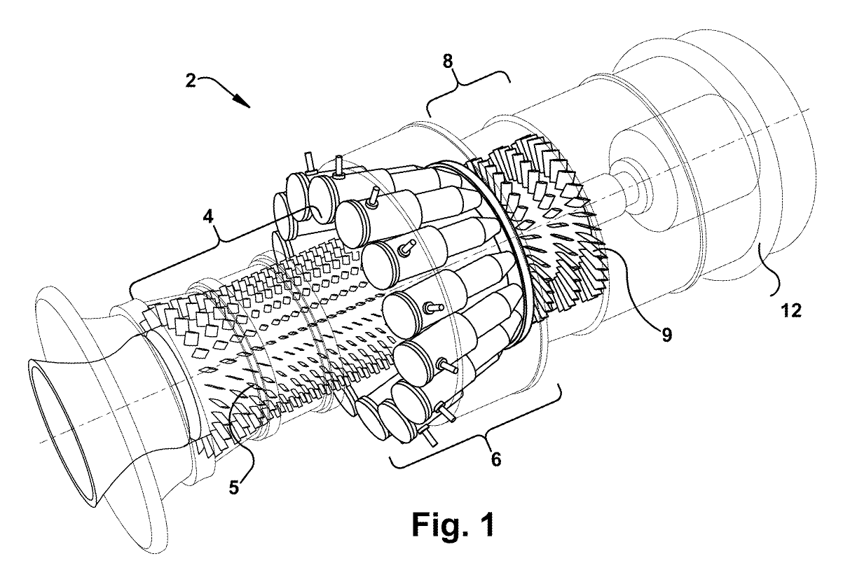

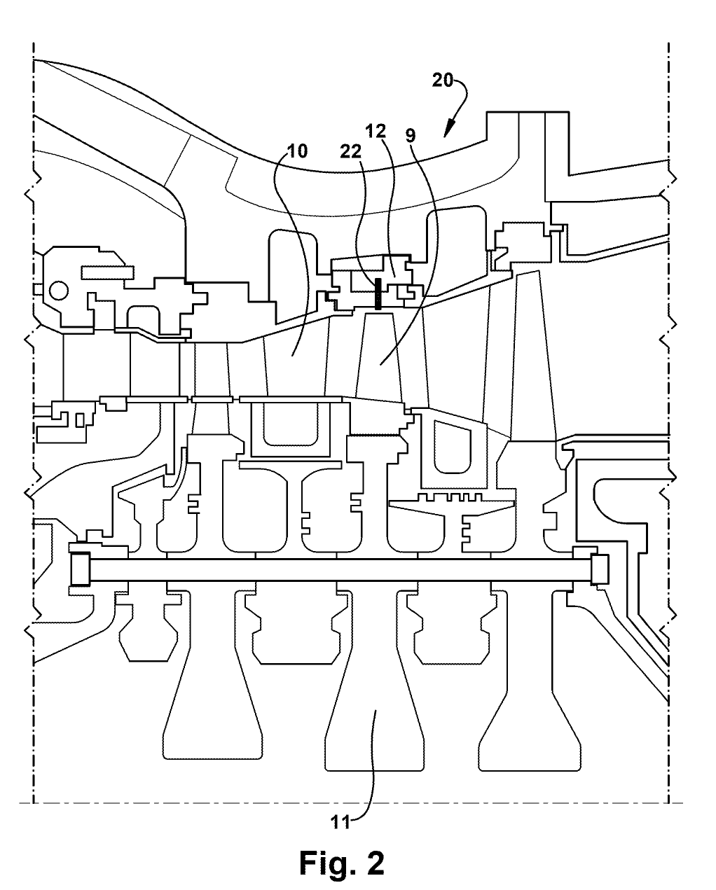

A technique has been developed to measure accurately, reliable, and at a relatively low cost the deformation of turbine blades in real time, i.e., as the gas turbine is operating. Referring now to FIG. 1, a typical gas turbine 2 is illustrated in which exemplary embodiments of the present invention may be used. While FIG. 1 depicts a gas turbine, it is understood that the present invention also may be used in steam turbines also. As shown, the gas turbine 2 may include a compressor 4, which may include several stages of compressor blades 5, that compresses a working fluid, i.e., air. The gas turbine 2 may include a combustor 6 that combusts a fuel with the compressed air. The gas turbine 2 further may include a turbine 8 that includes several stages of airfoils or turbine buckets or turbine blades 9, which convert the energy from the expanding hot gases into rotational mechanical energy. As used herein, the term “blades” will be used to refer to either compressor blades or turbine blades. The turbine 8 also may include diaphragms 10, as shown in FIG. 2, which are stationary components that direct the flow of hot gases onto the turbine blades 9. The gas turbine 2 may include a rotor 11 onto which the compressor blades 5 and turbine blades 9 are mounted. A turbine casing 12 may enclose the gas turbine 2.

As illustrated in FIG. 2, a blade radial deformation monitoring system 20 in accordance with the present invention may include one or more proximity sensors 22 that are spaced around the circumference of a single stage of compressor blades 5 or turbine blades 9. Specifically, the proximity sensors 22 may be mounted in the turbine casing 10 such that the proximity sensors 22 face a stage of compressor blades 5 or, as shown, a stage of turbine blades 9 from an outwardly radial position. In this manner, the proximity sensors 22 may measure the distance from the proximity sensor 22 to the tip of the compressor blade 5 or turbine blade 9, whatever the case may be. In some embodiments, the proximity sensor 22 may be an eddy current sensor, capacitive sensor, microwave sensor, laser sensor, or another similar type of device.

Through conventional means the sensors may be connected to a control system (not shown), which may receive, store and make calculations based on the proximity data acquired by the proximity sensors 22. The control system may comprise any appropriate high-powered solid-state switching device. The control system may be a computer; however, this is merely exemplary of an appropriate high-powered control system, which is within the scope of the application. For example, but not by way of limitation, the control system may include at least one of a silicon controlled rectifier (SCR), a thyristor, MOS-controlled thyristor (MCT) and an insulated gate bipolar transistor. The control system also may be implemented as a single special purpose integrated circuit, such as ASIC, having a main or central processor section for overall, system-level control, and separate sections dedicated performing various different specific combinations, functions and other processes under control of the central processor section. It will be appreciated by those skilled in the art that the control system also may be implemented using a variety of separate dedicated or programmable integrated or other electronic circuits or devices, such as hardwired electronic or logic circuits including discrete element circuits or programmable logic devices, such as PLDs, PALs, PLAs or the like. The control system also may be implemented using a suitably programmed general-purpose computer, such as a microprocessor or microcontrol, or other processor device, such as a CPU or MPU, either alone or in conjunction with one or more peripheral data and signal processing devices.

In use, the blade radial deformation monitoring system 20 may operate as follows. While this example of operation will relate to measuring the deformation of turbine blades 9, those of ordinary skill will recognize that the same general operation methodology may be applied to compressor blades 5. The proximity sensors 22 may take an initial measurement of each of the turbine blades 9 during the startup of the gas turbine 2. As one of ordinary skill in the art will appreciate, surface differences of each of the blades may identify each particular blade to the control system by the profile measured by the proximity sensors 22. Specifically, the minute surface differences of each of the blades may allow the control system to identify the individual blade and, thus, track the deformation of each individual blade. The initial measurement may indicate the initial length of each of the turbine blades 9. This may be determined by the known size and position of the rotor 11 and the distance measured from the proximity sensor 22 to the tip of each of the turbine bladed 9. That is, from these two values the length of the turbine blade 9 may be calculated. The initial measurement data may be stored by the control system.

As the gas turbine 2 operates, a later or second measurement may be taken. These measurements may be taken periodically; for example, they may be taken every second or every minute or every hour or some longer period. The second measurement may indicate the length of each of the turbine blades 9 at the time of the measurement. Again, this length may be determined by the known size and position of the rotor and the distance measured from the proximity sensor 22 to the tip of the turbine blade 9. From these two values the length of the turbine blade 9 may be calculated. The second measurement data may be stored by the control system.

The control system may process the measurement data to determine if the turbine blade 9 has deformed in the radial direction, i.e., whether the turbine blade has “stretched” during use. Specifically, the control system may compare the second measurement to the initial measurement to ascertain the amount of deformation or creep that has occurred. The control system may be programmed to alert a turbine operator once the deformation reaches a certain level. For example, the control system may provide a flashing alert to a certain computer terminal, send an email or a page to a turbine operator or use some other method to alert the turbine operator. This alert may be sent when the level of deformation indicates that the turbine blade 9 is nearing or is at the end of its useful life. At this point, the turbine blades 9 may be pulled from the gas turbine 2 and repaired or replaced.

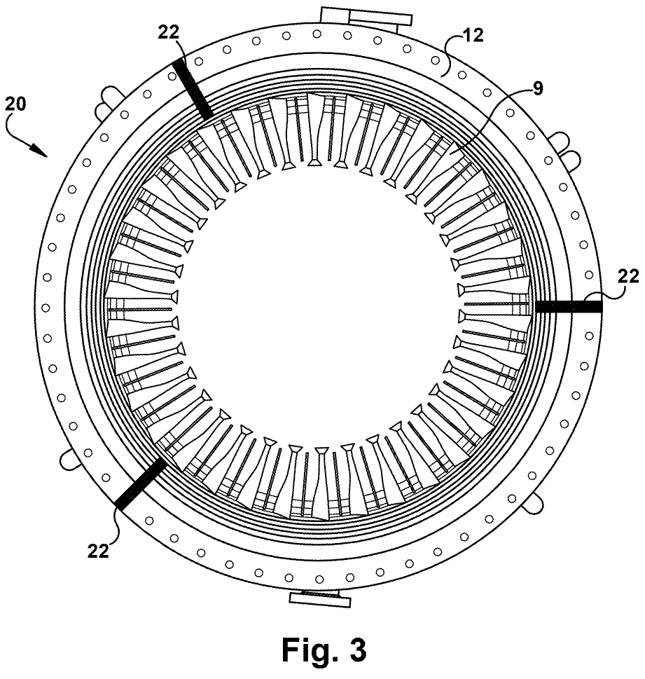

As stated, the blade radial deformation monitoring system 20 may include one or more proximity sensors 22. As illustrated in FIG. 3, the blade radial deformation monitoring system 20 may include three proximity sensors 22 evenly spaced around the circumference of the blades; though, those of ordinary skill in the art will recognize that more or less proximity sensors 20 may be used. The advantage of having multiple sensors is that the relative position of the rotor 11 in the casing 12 may be determined and accounted for in calculating the actual deformation or creep of the blades. Those of ordinary skill in the art will appreciate that changes in the relative position of the rotor with respect to the turbine casing 12 occur due to rotor sag, bearing movement, turbine casing out-of-round and other issues. This displacement may be taken for blade deformation if is not accounted for by the several proximity sensors 22. Thus, the displacement of the blades that may be attributed to rotor movement may be accounted for such that actual blade deformation is determined. For example, in the case of three sensors as shown in FIG. 3, measurement data may indicate that for one of the proximity sensors 22 one of the blades has stretched and for the other two proximity sensors 22 the blade has shrunk. These results indicate that the rotor has displaced inside the casing toward the proximity sensor 22 that shows the stretching. Per conventional methods, the control system may use an algorithm to determine the rotor displacement given the three measurements. Then, the control system may eliminate the rotor displacement to determine the actual radial deformation of each of the blades.

As stated, in some embodiments, only one proximity sensor 22 may be used. In such a system, it may be advantageous to used conventional rotor probes, such as a Bently probe, to determine rotor position. The rotor probes may be positioned at any point on the rotor and may measure the actual radial position of the rotor in real time. As stated, it will be understood by those skilled in the art that the rotor may displace radially during operation. This displacement may appear as deformation of the blades if the actual rotor positioning is not taken into account. If, on the other hand, the actual rotor displacement is calculated by the rotor probes, the control system may calculate the actual deformation of the blades.

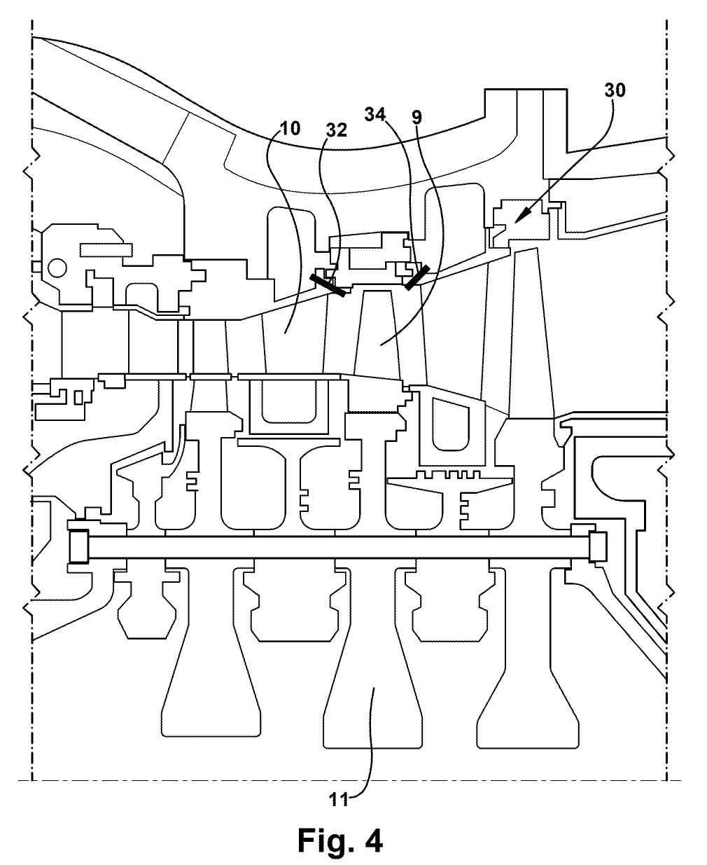

In some embodiments, the proximity sensors 22 may be located such that they measure axial deformation. As illustrated in FIG. 4, this may be accomplished by placing the proximity sensors 22 in a position such that they are observing the blades from a position that is upstream or in front of the axial position of the blade or from a position that is downstream or behind the axial position of the blade (i.e., the proximity sensors do not look down on the stage, but from an angled position). Thus, a blade axial deformation monitoring system 30 may include an upstream proximity sensor 32, a downstream proximity sensor 34, or both at one or more locations around the circumference of the stage. The upstream proximity sensor 32 may measure the distance from a fixed upstream location in the turbine casing 12 to the side of the blade. Likewise, the downstream proximity sensor 34 may measure the distance from a fixed downstream location in the turbine casing 12 to the side of the blade. Thus, any axial deformation in the upstream or downstream direction of the blade may be determined by examining the successive measurements taken by the upstream proximity sensor 32, the downstream proximity sensor 34, or both.

Similar to the blade radial deformation monitoring system 20, it may be advantageous for the blade axial deformation monitoring system 30 to have multiple proximity sensors 22 spaced about the circumference of the stage. The advantage of having multiple sensors is that the relative position of the rotor may be determined and accounted for in determining the actual axial creep of the blades.

As illustrated in FIG. 5, in some embodiments, the blade radial deformation monitoring system 20 and/or the blade axial deformation monitoring system 30 may be augmented with conventional infrared pyrometers 40 that provide a radial temperature profile of each of the blades. The infrared pyrometers used in such embodiments may be any conventional infrared pyrometer or similar devices. In use, the infrared pyrometers 40 may measure the radial temperature profile of each of the blades during operation. The control system may track the radial creep as measured by the proximity sensors 22 and/or the axial creep as measured by an upstream proximity sensor 32, and the radial temperature profile for each of the blades. The radial temperature profile will allow the control system to determine if any of the blades developed a “hot spot” (i.e., an area of increased temperature) during operation. With this information, the control system may determine if a greater percentage of either the measured axial or radial creep may be attributed to the area of the blade that coincides with the hot spot, as areas of increased temperature undergo deformation or creep at a faster rate. As one of ordinary skill in the art will appreciate, whether the creep is uniform throughout the blade or concentrated affects the anticipated life of the part. Thus, if it is determined that, because of a measured hot spot, the blade likely underwent concentrated creep or deformation, the anticipated life of the part will be decreased. If, on the other hand, it is determined that, because of the absence of any hot spots, the blade likely underwent uniform creep, the anticipated life of the part will not be decreased. In this manner, failure due to concentrated creep may be avoided.

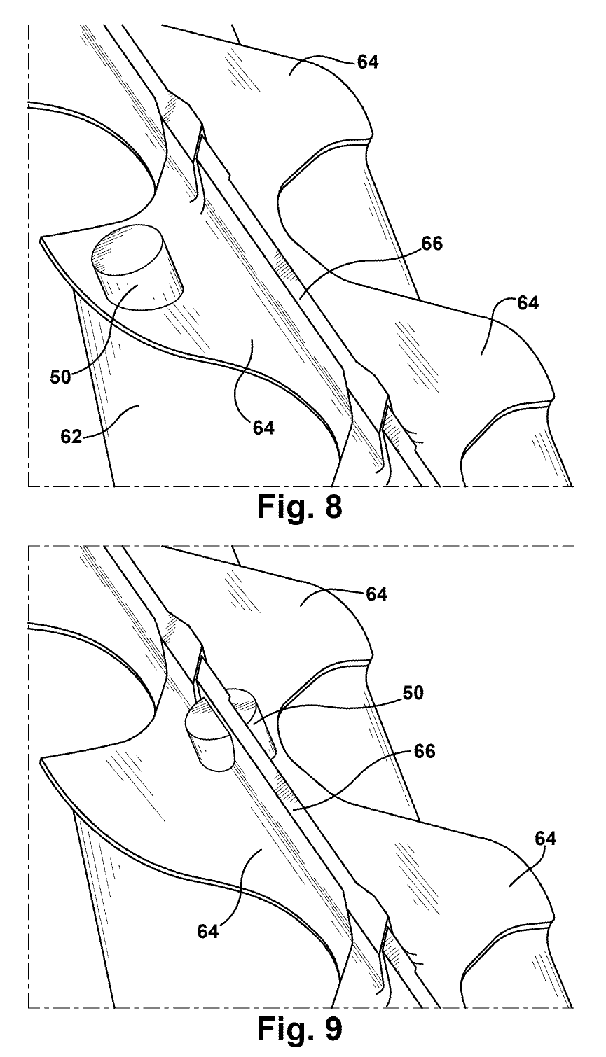

In some embodiments, as described below and illustrated on FIGS. 8 and 9, a target pad 50 may be connected to the tip (i.e., the outer most radial surface) of the compressor blade 5 or turbine blade 9 to increase the accuracy of the creep measurements taken by the proximity sensor 22. (From this point forward, the exemplary embodiment with the target pad 50 will be described in conjunction with the turbine blade 9. One of ordinary skill in the art will appreciate that the target pad 50 may also be used with the compressor blade 5.) As described above, radial creep may be determined by measuring the distance from an outwardly radial position to the tip of the turbine blade 9. The distance measured by the proximity sensor 22 between itself and the tip of the turbine blade 9 will decrease as the turbine blade 9 deforms in the radial direction, i.e., as the turbine blade 9 stretches along its length.

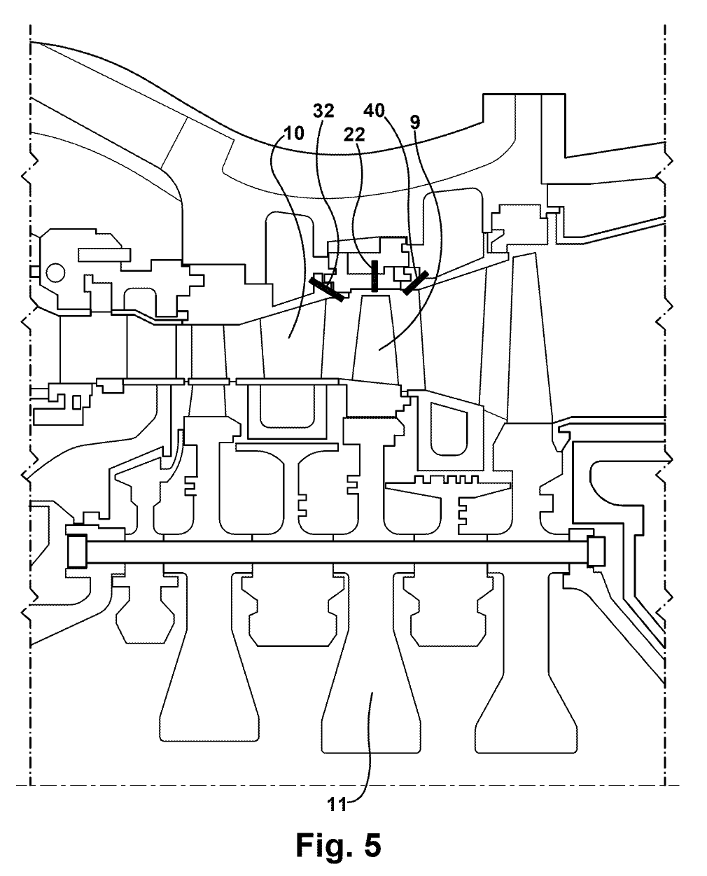

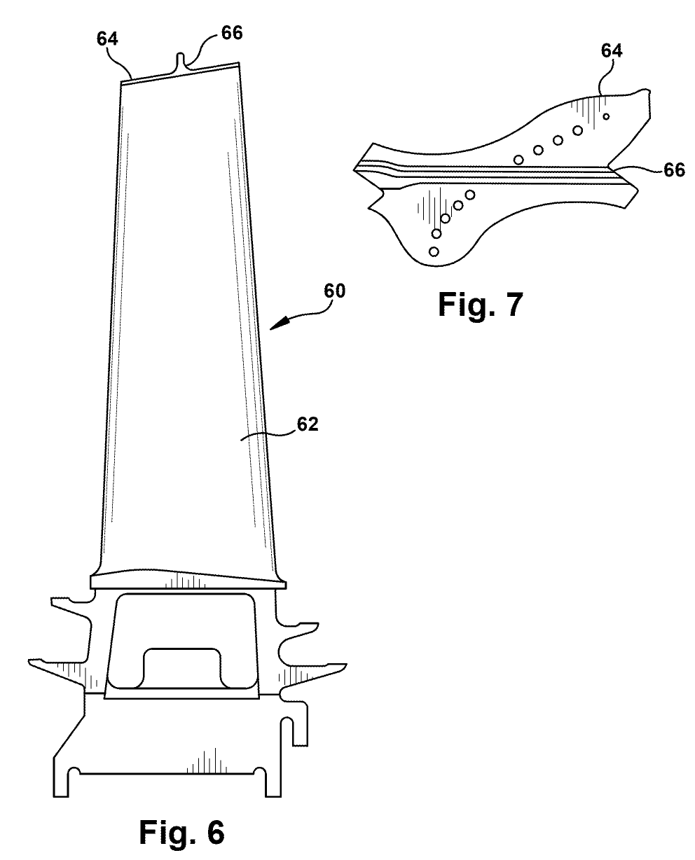

FIGS. 6 and 7 illustrate a conventional tip shrouded turbine bucket or turbine blade 60. The turbine blade 60 includes an airfoil 62. The airfoil 62 is the active component that intercepts the flow of gases and acts as a windmill vain to convert the energy of the gases into tangential motion. This motion in turn rotates the rotor to which the turbine blades 60 are attached. A tip shroud 64 may be positioned at the top of the airfoil 62. The tip shroud 64 essentially is a flat plate supported at its center by the airfoil 62. Positioned along the top of the tip shroud 64 may be a seal rail 66. Essentially the seal rail 66 prevents the passage of flow path gases through the gap between the tip shroud 64 and the inner surface of the surrounding components. The seal rail 66 is a ridge or fin that projects radially outward from the outermost surface of the tip shroud 64. The seal rail 66 extends circumferentially between opposite ends of the shroud in the direction of rotation of the turbine rotor, creating a seal that prevents flow path gases from bypassing the airfoil 62. Generally, the seal rail 66 extends radially into a groove formed in a stationary shroud opposing the rotating tip shroud, thus improving the seal.

As one of ordinary skill in the art will appreciate, conventional proximity sensors have a short range of operation. Thus, when used in conjunction with a tip shrouded turbine blade, as the one described above, the proximity sensor 22 generally must be aimed such that it measures the distance between itself and the seal rail 66, which, as already described, extends radially outward from the tip shroud 64. In other words, the distance between the turbine casing 12 or stationary shrouds (where the proximity sensors may be mounted) and the outer surface of the tip shroud 64 may be too great for conventional proximity sensors to take accurate measurements, thus requiring the proximity sensor to be aimed at the seal rail 66.

As one of ordinary skill in the art will appreciate, proximity sensors measure the distance between itself and an area on the surface of a nearby object, i.e., not a single point on the nearby object. This area may be called the “area of measurement” and, in general, is circular in nature. The width of the circular area of measurement generally is wider than the width of the seal rail 66. Thus, measurements taken in this manner include a measurement of the distance to the seal rail 66 as well as measurements of the surrounding area. This situation decreases the accuracy and quality of the readings. Poor readings of this type may make it difficult or impossible to accurately distinguish between each of the turbine blades. Of course, this result may make it impossible to track the creep for each of the individual turbine blades in the stage, which for reasons already discussed is desirable.

FIG. 8 is a perspective view of a tip shroud 64 with seal rail 66 and target pad 50. As shown, the target pad may be a raised surface that protrudes radially outward from outer face of the tip shroud 64. In some embodiments, the target pad may be cylindrical in shape such that an outer circular face is presented to the proximity sensor 22 during operation. The radial height of the target pad 50 may be less than the radial height of the seal rail 66 so that the target pad 50 does not rub against the stationary shrouds or turbine casing that circumferentially border the turbine blade stage.

In some embodiments, the area of the outer face of the target pad 50 may be similar in size to the area of measurement for the proximity sensor 22. Thus, when properly aligned, the area of measurement for the proximity sensor 22 may be approximately “filled” by the outer face of the target pad 50 when the target pad 50 passes by the proximity sensor 22, which will allow high quality readings to be taken. Such readings may allow the proximity sensor to more easily distinguish the different turbine blades in the stage, thus allowing the creep for each of the turbine blades to be tracked over time. In some embodiments, each target pad 50 may be configured to have a distinguishable elevation profile when read by the proximity sensor 22. In this manner, each of the turbine blades may be easily and accurately identifiable when its target pad 50 passes by the proximity sensor 22. FIG. 9 illustrates another exemplary embodiments in which the target pad 50 is made part of the seal rail 66.

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A tip shrouded turbine blade, comprising a target pad disposed on an outer radial surface of the tip shroud;
wherein the target pad comprises a raised surface that protrudes radially outward from the outer face of the tip shroud.

2. The tip shrouded turbine blade according to claim 1, wherein the target pad is substantially cylindrical in shape such that an outer radial face of the target pad is substantially circular in shape.

3. The tip shrouded turbine blade according to claim 2, the size of the surface area of the outer radial face of the target pad is configured to be substantially the same size as an area of measurement for a conventional proximity sensor.

4. The tip shrouded turbine blade according to claim 1, further including a seal rail, the seal rail comprising a fin that projects radially outward from the outer surface of the tip shroud.

5. The tip shrouded turbine blade according to claim 4, wherein the radial height of the target pad is less than the radial height of the seal rail.

6. The tip shrouded turbine blade according to claim 4, wherein the target pad is separate from the seal rail.

7. The tip shrouded turbine blade according to claim 4, wherein the target pad is part of the seal rail.

8. A set of tip shrouded turbine blades, each tip shrouded turbine blade including a target pad disposed on an outer radial surface of the tip shroud, the target pad comprising a raised surface that protrudes radially outward from the outer face of the tip shroud;
wherein the surface profile of the target pad for each of the tip shrouded turbine blades is configured to be distinguishable from the surface profile of the target pads for the other tip shrouded turbine blades in the set.

9. A blade for use in a turbine, the blade comprising a target pad disposed on an outer radial surface of the blade:
wherein the target pad comprises a raised surface that protrudes radially outward from the outer radial surface of the blade.

10. The blade according to claim 9, wherein the target pad is substantially cylindrical in shape such that an outer radial face of the target pad is substantially circular in shape.

11. A system for determining the radial deformation of a tip shrouded turbine blade, the system comprising:
one or more proximity sensors disposed around the circumference of a stage of blades, wherein the one or more proximity sensors take at least an initial measurement and a second measurement of the blade;
a control system that receives measurement data from the proximity sensors, and
a target pad disposed on the outward radial face of the tip shroud;
wherein the control system is configured to determine a radial deformation of the blade by comparing the initial measurement to the second measurement.

12. The system according to claim 11, wherein the initial measurement and second measurement each indicate the distance from a tip of the blade to the one or more proximity sensors.

13. The system according to claim 11, wherein the initial measurement and the second measurement are taken while the turbine is operating.

14. The system according to claim 11, wherein the number of the proximity sensors comprises two or more proximity sensors;
wherein the control system determines a rotor displacement from the measurements taken by the two or more proximity sensors; and
wherein the control system accounts for the rotor displacement when making the determination of the radial deformation of the blade.

15. The system according to claim 11, wherein the number of the proximity sensors comprises one proximity sensor; and
wherein the control system measures a rotor displacement with one or more rotor probes; and
wherein the control system accounts for the rotor displacement when making the determination of the radial deformation of the blade.

16. The system according to claim 11, wherein the target pad comprises a raised surface that protrudes radially outward from the outer face of the tip shroud.

17. The system according to claim 16, wherein the target pad is substantially cylindrical in shape such that an outer radial face of the target pad is substantially circular in shape.

18. The system according to claim 17, the size of the surface area of the outer radial face of the target pad is configured to be substantially the same size as an area of measurement for a conventional proximity sensor.

19. The system according to claim 16, further including a seal rail, the seal rail comprising a fin that projects radially outward from the outer surface of the tip shroud.

20. The system according to claim 19, wherein the radial height of the target pad is less than the radial height of the seal rail.

21. The system according to claim 19, wherein the target pad is separate from the seal rail.

22. The system according to claim 19, wherein the target pad is part of the seal rail.
